(19) United States
(12) Patent Application Publication
(10) Pub. No.: US 2010/0084333 A1
(43) Pub. Date: Apr. 8, 2010

(54) FABRICATION OF REINFORCED NANOPOROUS MEMBRANES

(75) Inventors: Arnold Hoogerwerf, Cormondreche (CH); Thomas Overstolz, St. Blaise (CH)

Correspondence Address: STEPTOE & JOHNSON LLP, 1330 CONNECTICUT AVENUE, N.W., WASHINGTON, DC, 20036, US

(73) Assignee: LIFECARE AS, Bergen (NO)

(21) Appl. No.: 12/530,406

(22) PCT Filed: Mar. 7, 2008
(86) PCT No.: PCT/NO08/00085

§ 371 Date: Dec. 7, 2009

Related U.S. Application Data
(60) Provisional application No. 60/905,311, filed on Mar. 7, 2007.

(51) Int. Cl. B01D 69/12; B44C 1/22

(52) U.S. Cl. 210/490; 216/39; 977/755; 977/888; 977/891

(57) ABSTRACT

The present invention discloses a method for manufacturing ultra-thin reinforced membranes from a SOI wafer having a front side and a back side, the front side having an etch stop layer buried under a device layer, provided for by forming reinforcement bars by etching openings in the device layer down to the etch stop layer, filling the openings at least partially by deposition of a first filler, and then polishing the top surface to the silicon surface before depositing a membrane material.

The present invention is related to the field of nanotechnology membranes, and especially to a mechanically reinforced ultra-flat thin membrane.

Nanotechnology membranes are used in many biological and medical applications. Prior Art thin membranes made of polymers have thicknesses of about ≧10 μm. The Norwegian patent application no. 20074244 disclose an apparatus and method for measuring augmented pressure in a reference cavity bounded on one side by a semi-permeable membrane. An example of application of such an apparatus is in vivo sensing of osmotic induced pressure gradients in the semi-permeable membrane, for example in vivo measurements of glucose levels in a human body fluid. The technical challenge for such an application is to provide a porous membrane with a pore size adapted to the molecule size in question, and at the same time be mechanically strong enough to withstand pressure differences across the two sides of the membrane due to the augmented osmotic pressure buildup on the side of the membrane facing toward the reference cavity. However, the main technical feature of this disclosure is that the membrane can be elastic to some extent providing a possibility to measure induced pressure gradients in the membrane itself. An apparatus according to this publication comprises a nanoporous membrane with a thickness of about 60 nm that can withstand a partial pressure difference ≧1 bar. The pore size is in the order of a few nanometers in diameter. Preferably the area of the membrane should be large enough to be responsive to small changes in osmotic induced pressure gradients in the membrane.

According to an aspect of the present invention, such a membrane can be manufactured with a mechanical reinforcement grid underneath the membrane. The size of the membrane area and the ratio between the membrane area and the membrane support structure is determined by the partial pressure difference across the membrane the membrane has to withstand. To be able to maximize the membrane area, the support structure has preferably a very fine mesh.

According to another aspect of the present invention a method is provided for manufacturing ultra-thin reinforced membranes from a SOI wafer having a front side and a back side, the front side having a etch stop layer buried under a device layer, wherein the method comprises the steps of:
(a) forming reinforcement bars by etching openings in the device layer down to the etch stop layer;
(b) filling the openings at least partially by deposition of a first filler;
(c) polishing the top surface to the silicon surface;
   before depositing a membrane material.

The method may further comprise the additional steps of
(d) depositing a second layer on the wafer; and
(e) polishing the second layer on the top side;
   before depositing a membrane material.

In yet another aspect of the present invention, the method may comprise the additional steps of:
(f) defining a backside opening;
(g) etching the wafer from the backside opening to the etch stop layer;
(h) etching the etch stop layer from the backside opening;
   before depositing a membrane material.

In another aspect of the present invention, the method may comprise the additional steps of:
(i) depositing the membrane material onto both sides of the second layer;
(j) photoresist protecting the membrane material on the front side;
(k) etching the membrane material on the back side;
(l) etching the second layer from the back side;

And in an additional aspect the method my comprise the additional step of:
(m)depositing a third layer onto the wafer.

In the aspects mentioned above, one or more of the following parameters may be incorporated:
the handling thickness of the wafer is about 380 μm;
the device layer is silicon, preferably having a thickness of about 20 μm;
the etch stop layer is an oxide, preferably silicon dioxide, preferably having a thickness of about 2 μm;
the first filler is TEOS oxide or polysilicon;
the second layer is polysilicon, preferably in a thickness of about 1 μm;
the third layer is polysilicon, preferably in a thickness of about 15 nm.

Further, one or more of the following specified processes may be used in the mentioned steps above:
the etching of step (a) and/or (g) is performed by photolito etching, preferably by DRIE (deep reactive ion etch);
the polishing of step (c) and/or step (e) is performed by CPM (chemical mechanical polishing);
the polishing of step (e) reduces the thickness of the second layer to about 0.7 μm;
the etching of step (h) is performed by vapour HF (hydrofluoric acid);
etching of step (k) is performed by BHF (buffered hydrofluoric acid) wetting;
the etching of step (l) is performed by KOH (potassium hydroxide);

According to yet another aspect of the present invention, the membrane material may be LPCVD (low pressure chemical vapour deposition) nitride, LPCVD poly-SI, or LPCVD Si₃N₄, preferably in a thickness of about 30 nm.

According to an example of method of manufacturing mechanically reinforced ultra-flat thin membranes according to the present invention, the support grid is first manufactured by etching holes in a silicon wafer (for example SOI (silicon-on-insulator) wafers) before the membrane itself is deposited on top of the support structure constituted by the etched holes in the silicon wafer. To achieve such an order of steps, the holes have to be temporarily filled and polished before the membrane is deposited on top of the support structure (or silicon wafer with etched holes). The step of polishing is necessary in order to achieve a certain predefined level of flatness of the deposited membrane since ultra thin membranes needs extremely flat surfaces to be able to deposit the thin membranes, for example a 60 nm thick membrane as discussed above may require a surface roughness below 5 nm. Further method steps provide a membrane suitable for a particular application (pore size) that can withstand a predefined partial pressure difference across the membrane (application environment).

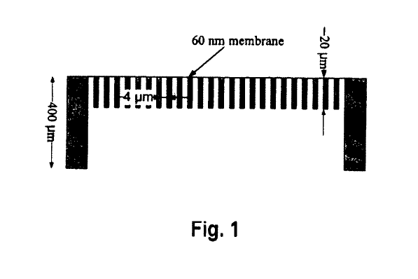

FIG. 1 depicts an example of a membrane manufactured according to the present invention.

FIG. 2 illustrates another method step according to an example of embodiment of the present invention.

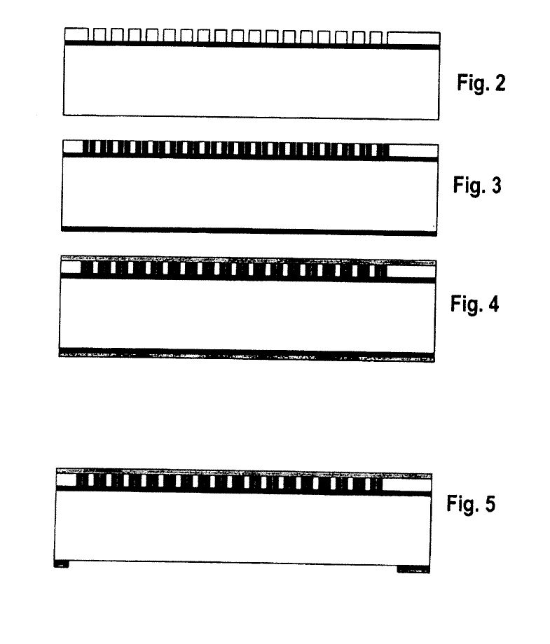

FIG. 3 illustrates yet another method step according to an example of embodiment of the present invention.

FIG. 4 illustrates yet another method step according to an example of embodiment of the present invention.

FIG. 5 illustrates yet another method step according to an example of embodiment of the present invention.

FIG. 6 illustrates yet another method step according to an example of embodiment of the present invention.

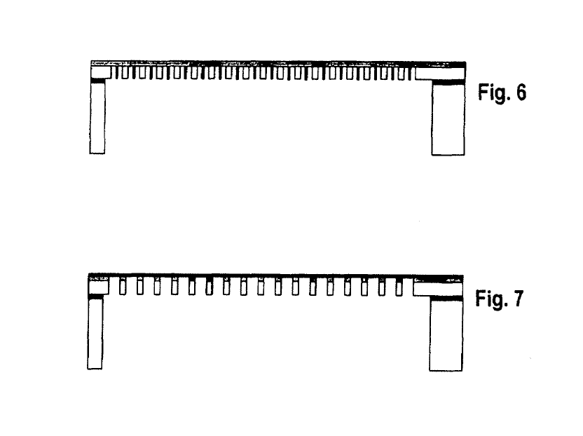

FIG. 7 illustrates yet another method step according to an example of embodiment of the present invention.

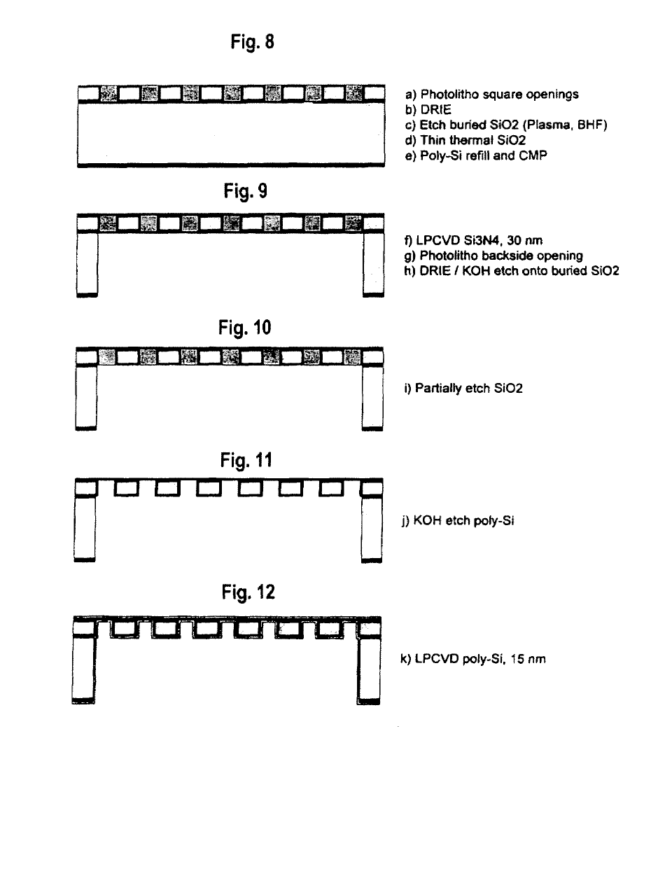

FIG. 8 to FIG. 12 illustrate steps of an alternative method for manufacturing according to the present invention.

In the following descriptions the following abbreviations and terms are used:

BHF: buffered hydrofluoric acid

CMP: Chemical Mechanical Polishing

DRIE: Deep Reactive Ion Etch

HF: Hydrofluoric acid

LPCVD: Low Pressure Chemical Vapour Deposition

KOH: Ptassium hydroxide

SOL Silicon-on-Insulator

TEOS: Tetraethoxysilane

Nanoporous membranes are used as semi permeable membranes and are used in a wide variety of applications such as filtering, osmosis, electrochemistry, or immuno-isolation. These membranes are typically made of polymeric materials with pore sizes ranging from a few nanometers to several microns. These membranes often have a thickness of several microns, which significantly slows down the diffusion of species through the long and narrow pores, as known to a person skilled in the art.

According to an aspect of the present invention, a mechanical reinforcement of the membrane makes it possible to manufacture ultra-thin membranes (for example 60 nm thick membranes). FIG. 1 illustrates an example of embodiment of a particular membrane according to the present invention. The design parameters of this example of embodiment is that the membrane should withstand a differential pressure of 4 bar, being only 60 nm thick and the area of the membrane is limited to 1 mm², which necessitate a mesh of support bars underneath the membrane of 20 μm thickness at a distance apart from each other of 4 μm. This provides the necessary mechanical strength of the membrane at the same time providing enough free membrane area for the pores.

The method of manufacturing a membrane according to the present invention is illustrated with reference to some practical examples of embodiments, which only are examples, and not any limiting features.

is With reference to the example depicted in FIG. 1, the fabrication starts with a SOI wafer having a device layer of 20 μm thicknesses, a buried oxide of 2 μm and a handling thickness of 380 μm. Holes of 4×4 μm² are etched in the device layer until reaching the oxide layer. Then the holes are filled, for example with a LPCVD TEOS oxide. Then the oxide on the top level is removed by Chemical Mechanical Polishing (CMP) providing a waffle like structure of silicon and oxide. A 1 μm thick polysilicon layer is then deposited on this surface and polished. In this example of embodiment, the thickness is reduced to about 0.7 μm.

This example of membrane front side processing is then followed by a backside photolithographic etching process. The silicon of the handling wafer (380 μm thick in this example) is then DRIE etched through to the buried oxide in 1×1 mm² areas that later constitutes the membranes manufactured out of this piece of material. A subsequent vapor HF etching can the remove the buried oxide and the TEOS oxide in the waffle structure.

The result so far of the method steps in this example of embodiment is a 0.7 μm thick polysilicon membrane reinforced by a 20 μm waffle like structure on the backside of the membrane. According to another aspect of the present invention, it is now possible to deposit a first membrane layer, for example a 30 nm LPCVD silicon nitride film. The nitride may be protected on the front side of the wafer with photo resist and is removed on the backside of the wafer and the polysilicon membrane using BHF etch. The wafer is placed for example in a chuck and the backside is etched in KOH to remove the polysilicon membrane. The polysilicon membrane is in this example of embodiment replaced by the silicon nitride membrane. A subsequent LPCVD deposition creates the desired polysilicon/silicon nitride stack according to the present invention.

The membrane manufactured so far according to an example of embodiment can then be processed to provide the necessary pores. The achieved flatness of the embodiment described above allows spin coating of a block-copolymer. As known to a person skilled in the art such co-polymers comprises two different polymers on each side of the chain. In a solvent that only dissolves one of the polymers, they form micelles which are often roughly spherical aggregates of several hundreds of polymer chains with diameters of tens to hundreds nanometers. When deposited with spin coating they form a film with nanometer topography that can be used as a mask when etching the underlying membrane providing either holes or pillars. Such techniques are disclosed in for example the article “Block Copolymer Micelles as Switchable Templates for Nanofabrication,” by S. Krishnamorrthy, et. al., Langmuir vol. 22, pp. 3450-3452, 2006. In an example of embodiment of the present invention, Polystyrene-block-poly-2-vinyl-pyridine copolymer with a 91 kDa (PS): 105 kDa (P2VP) polymer ratios provide a film with holes of 20-30 nm diameters. The copolymer pattern is transferred into the membrane sandwich by DRIE etching.

According to yet another aspect of the present invention, the pore size can be reduced in further post processing steps. It is known in prior art that etching holes below 10 nm is difficult to achieve since 10 nm is approximately the length of 50 aligned atoms. According to an example of embodiment of the present invention, pore hole size is reduced due to the fact that polysilicon will be oxidized to from about 2-4 nm of oxide in ambient atmosphere at room temperature (Ref. S. K. Ghandi, “Physics of semiconductor devices”). At higher temperatures, all the polysilicon will be converted into silicon oxide. The silicon oxide takes up twice the volume of polysilicon, which then will reduce the pore size of the pores. In an example of embodiment, the membrane is heated for one hour at 950° C. According to yet another aspect of the present invention, the reduction of the pore size can be tuned through a controlled oxidation of the polysilikon.

FIG. 2 illustrates the step of providing the waffle like support structure underneath the membrane. As disclosed in FIG. 2, the support structure is manufactured first without any membrane material present, by a photolithographic process as described above. The etching is stopped at the oxide layer 20.

FIG. 3 illustrates the step of deposition of TEOS oxide, and the subsequent polishing down to the top surface 21 of the silicon.

FIG. 4 illustrates the method step of deposition of polysilicon 22, and the subsequent polishing of the top surface of the polysilicon 22.

FIG. 5 illustrates the removal of the handling substrate 23 from the backside by using photolithography providing an etching mask 24 making it possible to etch away the central part 25 of the handling substrate 23, the etching mask in this example being 1 mm wide. According to an example of embodiment of the present invention, after the backside opening 25 has been defined, the etching begins. First the silicon is etched in a DRIE, stopping on the buried oxide layer 20. A 2 μm oxide layer is enough to stop the silicon etch effectively. Subsequently the silicon oxide is etched in a HF vapor is providing a freestanding polysilicon membrane with a smooth surface, as depicted in FIG. 6.

The next step according to an example of embodiment of the present invention, is to deposit LPCVD nitride (30 nm), which is the actual membrane material, wherein the deposition of the membrane material is provided for on both sides of the polysilicon membrane, wherein a photo resist protects the front while etching nitride in the backside with BHF. The resist is then removed followed by a short KOH etch. The result is illustrated in FIG. 7.

According to an alternative embodiment of the present invention, the TEOS silicon oxide is replaced by Poly-Si. FIG. 8 illustrates how photolithography is used to define square openings (defining the support structure) followed by DRIE etching. Then follows etch of buried SiO2 (for example plasma or BHF). A deposition of thin thermal SiO2 is followed by Poly-Si refill followed by polishing. FIG. 9 illustrates the membrane before depositing LPCVD Si3N4, 30 nm before defining an opening on the backside with photolithography followed by DRIE/KOH etching onto the buried SiO2. FIG. 10 illustrates partially etch of SiO2 while FIG. 11 illustrates KOH etch of Poly-Si. FIG. 12 illustrates the deposition of LPCVD Poly-Si, 15 nm.

1. A method for manufacturing ultra-thin reinforced membranes from an SOI wafer having a front side and a back side, the front side having a etch stop layer buried under a device layer, wherein the method comprises the steps of:
(a) forming reinforcement bars by etching openings in the device layer down to the etch stop layer;
(b) filling the openings at least partially by deposition of a first filler;
(c) polishing the top surface to the silicon surface;
before depositing a membrane material.

2. The method according to claim 1, comprising the additional steps of:
(d) depositing a second layer on the wafer; and
(e) polishing the second layer on the top side;
before depositing a membrane material.

3. The method according to claim 2, comprising the additional steps of:
(f) defining a backside opening;
(g) etching the wafer from the backside opening to the etch stop layer;
(h) etching the etch stop layer from the backside opening;
before depositing a membrane material.

4. The method according to claim 3, further comprising the steps of:
(i) depositing a membrane material onto both sides of the second layer;
(j) photoresist protecting the membrane material on the front side;
(k) etching the membrane material on the back side;
(l) etching the second layer from the back side;

5. The method according to claim 4, comprising the additional step of:
(m) depositing a third layer onto the wafer.

6. The method according to claim 1, wherein the wafer has a handling thickness of about 380 μm.

7. The method according to claim 1, wherein the device layer is silicon, preferably having a thickness of about 20 μm.

8. The method according to claim 1, wherein the etch stop layer is an oxide or a silicon dioxide.

9. The method according to claim 1, wherein the first filler is TEOS oxide or polysilicon.

10. The method according to claim 2, wherein the second layer is polysilicon.

11. The method according to claim 5, wherein the third layer is polysilicon.

12. The method according to claim 1, wherein the etching of step (a) is performed by photolito etching.

13. The method according to claim 1 wherein polishing of step (c) is performed by CPM (chemical mechanical polishing).

14. The method according to claim 2, wherein polishing of step (e) reduces the thickness of the second layer to about 0.7 μm.

15. The method according to claim 3, wherein the etching of step (h) is performed by vapour HF (hydrofluoric acid).

16. The method according to claim 4, wherein the membrane material is elected to be one of: LPCVD (low pressure chemical vapour deposition) nitride, LPCVD poly-SI, and LPCVD Si₃N₄.

17. The method according to claim 4, wherein the etching of step (k) is performed by BHF (buffered hydrofluoric acid) wetting.

18. The method according to claim 4, wherein the etching of step (l) is performed by using KOH (potassium hydroxide).

19. The method according to claim 7, wherein the device layer has a thickness of about 20 μm.

20. The method according to claim 3, wherein the etch stop layer is an oxide or a silicon dioxide.

21. The method according to claim 8, wherein the etch stop layer has a thickness of about 2 μm.

22. The method according to claim 20, wherein the etch stop layer has a thickness of about 2 μm.

23. The method according to claim 2, wherein the second layer has a thickness of about 1 μm.

24. The method according to claim 11, wherein the third layer has a thickness of about 15 nm.

25. The method according to claim 3, wherein the etching of at least one of step (a) and step (g) is performed by photolito etching.

26. The method according to claim 12, wherein the etching is a DRIE (deep reactive ion etch).

27. The method according to claim 25, wherein the etching is a DRIE (deep reactive ion etch).

28. The method according to claim 16, wherein the membrane material has a thickness of about 30 nm.

29. An ultra-thin membrane manufactured from an SOI wafer having a front side and a back side, the front side having a etch stop layer buried under a device layer, the membrane being made by:
(a) forming reinforcement bars by etching openings in the device layer down to the etch stop layer;
(b) filling the openings at least partially by deposition of a first filler;
(c) polishing the top surface to the silicon surface;
(d) depositing a second layer on the wafer;
(e) polishing the second layer on the top side;
(f) defining a backside opening;
(g) etching the wafer from the backside opening to the etch stop layer;
(h) etching the etch stop layer from the backside opening;
(i) depositing a membrane material onto both sides of the second layer;
(j) photoresist protecting the membrane material on the front side;
(k) etching the membrane material on the back side;
(l) etching the second layer from the back side; and
(m) depositing a third layer onto the wafer,
wherein the membrane material of the membrane is one of:
LPCVD (low pressure chemical vapour deposition) nitride, LPCVD poly-SI, and LPCVD Si₃N₄.

30. The ultra-thin membrane according to claim 29, wherein the membrane material has a thickness of about 30 nm.

31. The ultra-thin membrane according to claim 29,
wherein the SOI wafer has a handling thickness of about 380 μm,
wherein the device layer is silicon having a thickness of about 20 μm,
wherein the first filler is TEOS oxide or polysilicon, and
wherein the second and third layers are of polysilicon, the second layer having a thickness of about 0.7 μm subsequent to polishing, and the third layer having a thickness of about 15 nm.
